(19) United States
(12) Patent Application Publication
(10) Pub. No.: US 2015/0167370 A1
(43) Pub. Date: Jun. 18, 2015

(54) RAIL LOCKING DEVICE

(71) Applicants: Hyundai Motor Company, Seoul (KR); Kwangjin Co., Ltd., Asan-si (KR)

(72) Inventors: Jae Hong CHOI, Gwangmyeong-si (KR); YoungBae Gong, Ansan-si (KR)

(73) Assignees: Hyundai Motor Company, Seoul (KR); Kwangjin Co., Ltd., Asan-si (KR)

(21) Appl. No.: 14/470,737

(22) Filed: Aug. 27, 2014

(30) Foreign Application Priority Data
Dec. 17, 2013 (KR) 10-2013-0157591

(51) Int. Cl. E05C 17/60; E05D 15/06

(52) U.S. Cl. CPC E05D 13/04; E05D 15/0626

(57) ABSTRACT

Disclosed is a rail locking device. The rail locking device may include a movable rail, a slider that is embedded in the rail to move in a sliding motion along with movement of the rail, a swing arm that supports the slider to move in a swing motion, and a locking member that is attached to the slider to lock the rail to the slider or unlock the rail from the slider. Accordingly, it is possible to easily lock and unlock the rail, and it is possible to open or close a vehicle door in a longitudinal direction of a vehicle when the vehicle door is provided.

### CROSS-REFERENCE TO RELATED APPLICATION

The present application claims priority of Korean Patent Application Number 10-2013-0157591 filed on Dec. 17, 2013, the entire contents of which application are incorporated herein for all purposes by this reference.

### BACKGROUND OF INVENTION

1. Field of Invention

The present invention relates to a rail locking device, and more particularly, to a rail locking device capable of allowing a rail and a slider embedded in the rail to move in a relative motion by automatically locking the rail to a latch when the rail is moved rearward and by automatically unlocking the rail from the latch when the rail is moved forward in a rotary motion.

2. Description of Related Art

In general, a slider-rail device is configured such that a slider having a moving roller is inserted into a rail forming a certain track and the slider is slidably moved along the track of the rail by a rotary motion of the roller.

The rail has a predetermined length, and is attached to be fixed while forming a certain moving track. Meanwhile, the slider is attached to a moving body that moves along the rail, and the moving body is moved along the moving track formed by the rail.

Further, a locking device that temporarily locks the slider to a predetermined position of the rail to restrict the slider so as not to be moved along the rail or releases the restriction of the slider to be moved along the rail may be further provided at the rail or the slider.

On the other hand, there is a rail-slider device configured such that the slider is restricted by a fixed body so as not to be moved and the rail is attached to a moving body, so that the rail can be moved while being supported by the slider and the fixed body.

In the rail-slider device, it is necessary to provide a locking device that unlocks the rail from the slider so as to allow the rail and the slider to be integrally restricted along with the motion of the rail or to allow the rail and the slider to move in a relative motion. Accordingly, the present invention relates to a locking device that temporarily restricts the rail by the slider to allow the rail not to be moved or unlocks the rail from the slider to allow the rail to be moved while being supported by the slider in the rail-slider device.

The information disclosed in this Background section is only for enhancement of understanding of the general background of the invention and should not be taken as an acknowledgement or any form of suggestion that this information forms the prior art already known to a person skilled in the art.

### SUMMARY OF INVENTION

The present invention has been made in an effort to provide a rail locking device having advantages of smoothly and automatically lock and unlock a rail and a slider by automatically locking the rail to the slider when the rail is moved rearward and by automatically unlocking the rail from the slider when the rail is moved forward in a rotary motion.

Various aspects of the present invention provide a rail locking device. The rail locking device may include a movable rail, a slider that is embedded in the rail to move in a sliding motion along with movement of the rail, a swing arm that supports the slider and moves in a swing motion, and a locking member that is attached to the slider to lock the rail to the slider or unlock the rail from the slider.

A striker may be attached to the rail to be fixed, and the locking member may be hooked to the striker to lock the rail to the slider through the striker, or the locking member is separated from the striker to unlock the rail from the slider. The locking member may be operated by the swing motion of the swing arm to unlock the striker.

The rail may include a central rail that is positioned at a center portion in a height direction, an upper rail that is positioned higher than the central rail; and a lower rail that is positioned lower than the central rail. The central rail, the upper rail and the lower rail each may have a cross section of a “U” shape that is continuous in a longitudinal direction, openings of the upper rail and the lower rail may be disposed to be substantially perpendicular to an opening of the central rail, and the openings of the upper rail and the lower rail may face each other, and the striker may be attached to a bottom surface of a predetermined portion of the central rail in the longitudinal direction to protrude upward in the height direction.

The slider may include a slider body having a substantially square flat shape and at least one roller that is rotatably provided at the slider body. The at least one roller may include two central rail rollers that are attached to a front surface of the slider body, and are inserted into the central rail to move in a rotary motion along with the movement of the rail, two upper rail rollers that are attached to the front surface of the slider body, and are inserted into the upper rail to move in a rotary motion along with the movement of the rail, and two lower rail rollers that are attached to the front surface of the slider body, and are inserted into the lower rail to move in a rotary motion along with the movement of the rail.

An upper flange and a lower flange may be respectively formed to protrude from both edges of the slider body in a width direction, and one end of the swing arm may be inserted between the upper flange and the lower flange to be rotatably fastened.

The swing arm may include a swing arm body, a cylindrical first flange that protrudes from one end of the swing arm body, and is inserted between the upper flange and the lower flange to be fastened by a first assembly pin, and two second flanges that are formed at left and right sides of the other end of the swing arm body in the width direction. A part of the first flange may be cut off, a pressurization edge that pressurizes the locking member to rotate the locking member may be formed at one edge of the cut-off portion, and a return spring may be embedded in the first flange.

The second flanges of the swing arm body may be fastened to a mounting bracket by a second assembly pin, and a return spring that returns the swing arm may be provided at the second assembly pin.

The locking member may include first and second latches that are rotatably provided at the lower flange of the swing arm body through third and fourth assembly pins.

The first latch may include a hook that is formed at one portion from the assembly, a pressed protrusion that is formed at a side opposite to the hook with respect to the third assembly pin to be pressed by the pressurization edge, and a pressurizing spring that is provided at an outer circumference of the third assembly pin to pressurize the hook in one direction.

The second latch may include a hook that has an open engagement groove formed by a first side having a short length and a second side having a long length longer than that of the first side, the second side being substantially parallel to the first side, the striker being detachably inserted into the engagement groove, an engagement protrusion that is detachably hooked to the hook of the first latch, and a pressurizing spring that pressurizes the hook in one direction.

The rail may be attached to a vehicle door, and the swing arm may be attached to a vehicle body to move in the swing motion.

According to various aspects of the present invention, in the rail locking device, when the rail is moved rearward, the latch of the slider is automatically hooked to the striker of the rail to integrally restrict the rail, the striker, and the slider. Meanwhile, when the rail is moved forward in a rotary motion, a slider support supporting the slider moves in a swing motion by the rail to operate the latch, and, thus, the restriction of the striker and the latch are released. Accordingly, the rail with the slider inserted is moved forward, so that the rail can be automatically and the smoothly locked and unlocked.

When the rail is provided at the vehicle door and the slider is embedded in the rail while the slider support is fixed to the vehicle body, it is possible to open or close the vehicle door back and forth in the longitudinal direction of the vehicle. Furthermore, since an attachment opening of the vehicle door formed in the vehicle body can be completely opened, it is possible to provide convenience in getting into or out of the vehicle.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 is a perspective view illustrating an exemplary locking device according to the present invention when a rail is locked to a slider.

FIGS. 2 and 3 are perspective views of an exemplary slider according to the present invention.

FIG. 4 is a perspective view of an exemplary swing arm according to the present invention.

FIG. 5 is a perspective view of an exemplary first latch and an exemplary second latch according to the present invention.

FIG. 6 is a perspective view illustrating a state where an exemplary second latch is unlocked to an exemplary first latch according to the present invention.

FIG. 7 is a perspective view illustrating a state where a rail is unlocked from an exemplary locking device according to the present invention.

### DETAILED DESCRIPTION

Reference will now be made in detail to various embodiments of the present invention(s), examples of which are illustrated in the accompanying drawings and described below. While the invention(s) will be described in conjunction with exemplary embodiments, it will be understood that present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

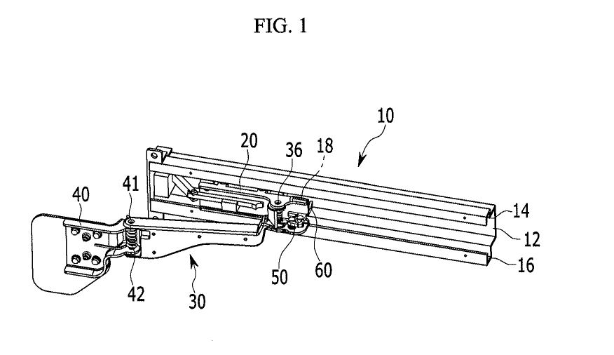

Referring to FIG. 1, a rail locking device according to various embodiments of the present invention may include a rail 10. The rail 10 may include a central rail 12 that is positioned at a center or a center portion in a height direction, an upper rail 14 that is positioned higher than the central rail 12, and a lower rail 16 that is positioned lower than the central rail 12. The rail 10 may be formed by integrally or monolithically forming the central rail 12, the upper rail 14 and the lower rail 16.

The central rail 12, the upper rail 14 and the lower rail 16 may have a structure in which cross sections of a “U” shape are continuous in a longitudinal direction. Openings of the upper rail 14 and the lower rail 16 may be disposed to be perpendicular or substantially perpendicular to an opening of the central rail 12, and the openings of the upper rail 14 and the lower rail 16 may formed in a direction facing each other.

A striker 18 may be attached to a bottom surface of a predetermined portion of the central rail 12 in a longitudinal direction so as to protrude upward in the height direction. The striker 18 may have a substantially “U” shape.

The rail 10 may be attached to a moving body such as a vehicle door.

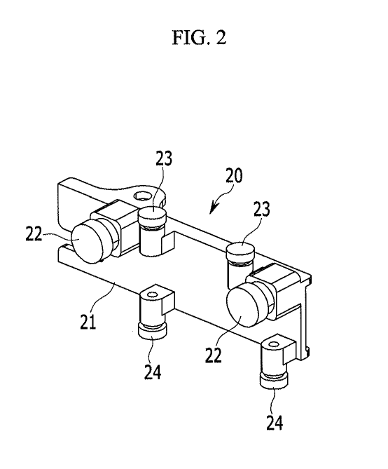

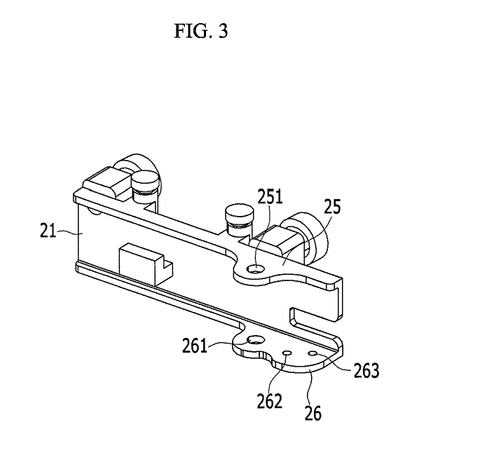

Referring to FIGS. 1 to 3, a slider 20 may be provided at the rail 10 to be movably inserted. The slider 20 may include a slider body 21 having a substantially square flat shape.

Two central rail rollers 22 that are inserted into the central rail 12 to move in a rotary motion along with movement of the rail 10 may be rotatably attached to a front surface of the slider body 21 while being disposed with a predetermined distance in a width direction.

Two upper rail rollers 23 that are inserted into the upper rail 14 to move in a rotary motion along with the movement of the rail 10 may be disposed at the front surface of the slider body 21 with a predetermined distance in the width direction, and may be rotatably attached upward.

Two lower rail rollers 24 that are inserted into the lower rail 16 to move in a rotary motion along with the movement of the rail 10 may be disposed at the front surface of the slider body 21 with a predetermined distance in the width direction, and may be rotatably attached downward.

An upper flange 25 and a lower flange 26 may be respectively formed at both edges of the slider body 21 in the width direction to vertically protrude, a first assembly hole 251 may be formed in the upper flange 25, and a first assembly hole 261, a second assembly hole 262, and a third assembly hole 263 may be formed in the lower flange.

One end of a swing arm 30 may be inserted between the upper flange 25 and the lower flange 26 of the slider body 21 to be rotatably fastened.

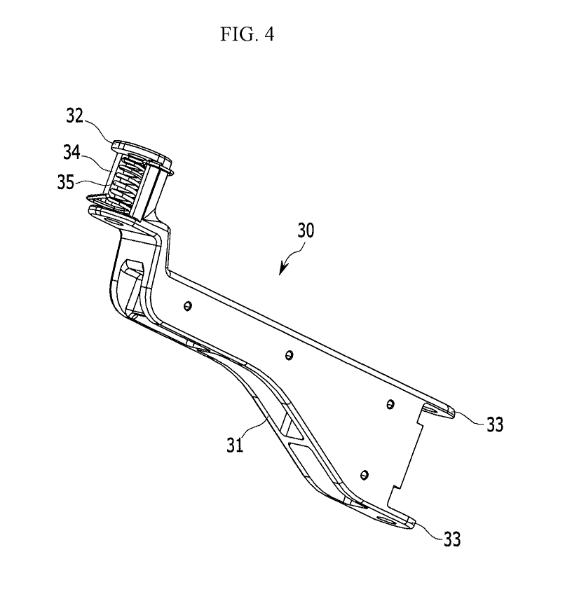

Referring to FIG. 4, the swing arm 30 may include a swing arm body 31, a cylindrical first flange 32 that protrudes to integrally or monolithically extend from one end of the swing arm body 31, and two second flanges 33 that are disposed at left and right sides of the other end of the swing arm body 32 in the width direction and protrude to integrally or monolithically extend.

A part of the first flange 32 is cut off, and a pressurization edge 34 that presses and rotates a latch to be described below is formed at one edge of the cut-off portion.

A return spring 35 is embedded in a circular or substantially circular inner space of the first flange 32, and the return spring 35 serves to return the swing arm 30 after moving in a swing motion to an original position. The first flange 32 of the swing arm 30 is inserted between the upper flange 25 and the lower flange 26 of the slider body 21 to be rotatably fastened by an assembly pin 36.

Referring to FIG. 1, the second flanges 33 of the swing arm body 31 may be fastened to a mounting bracket 40 to be supported. One end of the mounting bracket 40 may be inserted between the two second flanges 33 of the swing arm body 31 to be fastened by an assembly pin 41. Accordingly, the swing arm 30 can move a relative swing motion with respect to the mounting bracket 40.

After the swing arm 30 moves in the swing motion with respect to the mounting bracket 40, in order to return the swing arm 30 to an original position, the return spring 42 may be provided to be wound around an outer circumference of the assembly pin 41.

The mounting bracket 40 may be attached to a fixed body such as a vehicle body to be fixed.

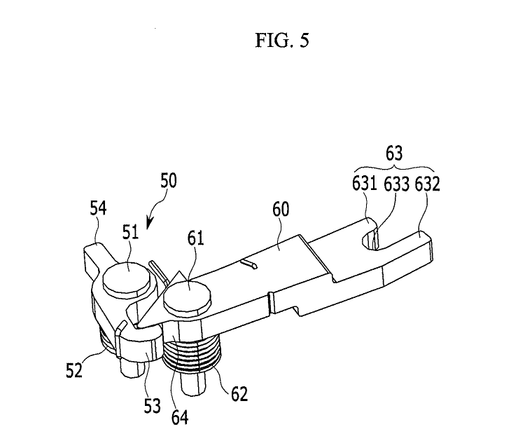

Referring to FIGS. 1 and 5, two first and second latches 50 and 60 may be rotatably provided at the lower flange 26 of the slider body 21.

The first latch 50 may be assembled with the second assembly hole 262 by an assembly pin 51. A pressurizing spring 52 that pressurizes the first latch 50 in a clockwise direction may be provided to be wound around an outer circumference of the assembly pin 51. The first latch 50 may include a hook 53. The first latch 50 may include a pressed protrusion 54 that is formed to protrude from a side opposite to the hook 53 from the assembly pin 51 and is pressed by the pressurization edge 34.

The second latch 60 may be assembled with the third assembly hole 263 by an assembly pin 61. A pressurizing spring 62 that pressurizes the second latch 60 in the clockwise direction may be provided to be wound around an outer circumference of the assembly pin 61. The second latch 60 may include a hook 63 having an open engagement groove 633 that is formed by a first side having a short length and a second side having a relatively long length than the first side to be substantially parallel to the first side, and the hook 63 may be detachably hooked to the striker 18 through the open engagement groove 633. The second latch 60 may include an engagement protrusion 64 that is detachably hooked to the hook 53 of the first latch 50.

The first latch 50 and the second latch 60 constitutes a locking member that locks or unlocks the rail 10 to or from the slider 20.

FIG. 1 illustrates a state where the rail 10 and the slider 20 are integrally restricted through the two first and second latches 50 and 60. Accordingly, the rail 10 and the slider 20 do not move in a relative motion to each other.

The slider 20 may be supported by the fixed body such as a vehicle body through the swing arm 30 and the mounting bracket 40.

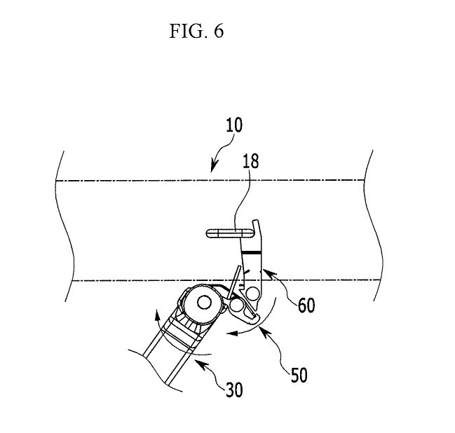

In FIG. 6, when the swing arm 30 is rotated by about 80 degrees, the pressurization edge 34 of the swing arm 30 presses the pressed protrusion 54 of the first latch 50, and, thus, the first latch 50 is rotated around the assembly pin 51 in a counterclockwise direction. Accordingly, the engagement protrusion 64 of the second latch 60 is released from the hook 53 of the first latch 50, and, thus, the second latch 60 is freed from the first latch 50.

Accordingly, the rail 10 is restricted by the slider 20 through only the second latch 60 hooked to the striker 18, and the striker 18 is inserted into the open engagement groove 633 of the hook 63 of the second latch 60 to be hooked.

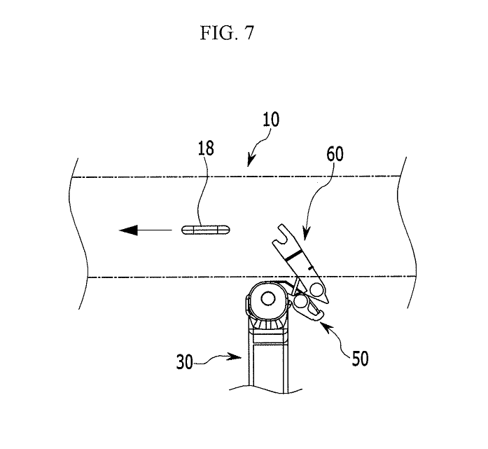

In this state, when the rail 10 moves in a direction spaced apart from the second latch 60 as illustrated in FIG. 7, since the striker 18 of the rail 10 is naturally separated along an opening of the engagement groove 633, the restriction of the rail 10 by the slider 20 is released.

Accordingly, the rail 10 can move forward while being supported by the slider 20, and the rollers of the slider 20 embedded in the rail 10 move in a rotary motion along with the movement of the rail 10 while coming in contact with the rail 10. Thus, the motion of the rail 10 is smoothly moved.

When the rail 10 is attached to the vehicle door and the swing arm 30 is attached to the vehicle body through the mounting bracket 40, the vehicle door is smoothly moved forward, so that a vehicle compartment can be opened.

Meanwhile, when the rail 10 is moved rearward, the two first and second latches 50 and 60 are hooked to the striker 18, and, thus, the rail 10 is connected to the slider 20 to be restricted. The rail 10 is hooked to the fixed body such as the vehicle body by the slider 20 through the swing arm 30 and the mounting bracket 40 to be supported.

That is, when the rail 10 is provided at the vehicle door, the vehicle door is supported by the vehicle body while closing a door opening formed in the vehicle body.

For convenience in explanation and accurate definition in the appended claims, the terms “upper” or “lower”, “forward” or “rearward”, “inner” or “outer”, and etc. are used to describe features of the exemplary embodiments with reference to the positions of such features as displayed in the figures.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. A rail locking device comprising:
a movable rail;
a slider that is embedded in the rail to move in a sliding motion along with movement of the rail;
a swing arm that supports the slider to move in a swing motion; and
a locking member that is attached to the slider to lock the rail to the slider or unlock the rail from the slider.

2. The rail locking device of claim 1, wherein:
a striker is attached to the rail to be fixed, and
the locking member is hooked to the striker to lock the rail to the slider through the striker, or the locking member is separated from the striker to unlock the rail from the slider.

3. The rail locking device of claim 2, wherein:
the locking member is operated by the wing motion of the swing arm to unlock the striker.

4. The rail locking device of claim 3, wherein the rail includes:
a central rail that is positioned at a center portion in a height direction;
an upper rail that is positioned higher than the central rail; and
a lower rail that is positioned lower than the central rail.

5. The rail locking device of claim 4, wherein:
the central rail, the upper rail and the lower rail each has a cross section of a “U” shape that is continuous in a longitudinal direction,
openings of the upper rail and the lower rail are disposed to be substantially perpendicular to an opening of the central rail, and the openings of the upper rail and the lower rail face each other, and
the striker is attached to a bottom surface of a predetermined portion of the central rail in the longitudinal direction to protrude upward in the height direction.

6. The rail locking device of claim 4, wherein the slider includes:
a slider body having a substantially square flat shape; and
at least one roller that is rotatably provided at the slider body.

7. The rail locking device of claim 6, wherein the at least one roller includes:
two central rail rollers that are attached to a front surface of the slider body, and are inserted into the central rail to move in a rotary motion along with the movement of the rail;
two upper rail rollers that are attached to the front surface of the slider body, and are inserted into the upper rail to move in a rotary motion along with the movement of the rail; and
two lower rail rollers that are attached to the front surface of the slider body, and are inserted into the lower rail to move in a rotary motion along with the movement of the rail.

8. The rail locking device of claim 6, wherein:
an upper flange and a lower flange are respectively formed to protrude from both edges of the slider body in a width direction, and
one end of the swing arm is inserted between the upper flange and the lower flange to be rotatably fastened.

9. The rail locking device of claim 8, wherein the swing arm includes:
a swing arm body;
a cylindrical first flange that protrudes from one end of the swing arm body, and is inserted between the upper flange and the lower flange to be fastened by a first assembly pin, and
two second flanges that are formed at left and right sides of the other end of the swing arm body in the width direction,
wherein a part of the first flange is cut off, and a pressurization edge that pressurizes the locking member to rotate the locking member is formed at one edge of the cut-off portion, and
a return spring is embedded in the first flange.

10. The rail locking device of claim 9, wherein:
the second flanges of the swing arm body are fastened to a mounting bracket by a second assembly pin, and
a return spring that returns the swing arm is provided at the second assembly pin.

11. The rail locking device of claim 9, wherein the locking member includes first and second latches that are rotatably provided at the lower flange of the swing arm body through third and fourth assembly pins.

12. The rail locking device of claim 11, wherein the first latch includes:
a hook that is formed at one portion from the third assembly pin;
a pressed protrusion that is formed at a side opposite to the hook with respect to the third assembly pin to be pressed by the pressurization edge; and
a pressurizing spring that is provided at an outer circumference of the third assembly pin to pressurize the hook in one direction.

13. The rail locking device of claim 11, wherein the second latch includes:
a hook that has an open engagement groove formed by a first side having a short length and a second side having a long length longer than that of the first side, the second side being substantially parallel to the first side, the striker being detachably inserted into the engagement groove;
an engagement protrusion that is detachably hooked to the hook of the first latch; and
a pressurizing spring that pressurizes the hook in one direction.

14. The rail locking device of claim 11, wherein:
the rail is attached to a vehicle door, and
the swing arm is attached to a vehicle body to move in the swing motion.
